(19) United States
(12) Patent Application Publication
(10) Pub. No.: US 2011/0303300 A1
(43) Pub. Date: Dec. 15, 2011

(54) METHOD OF OPERATING A MOTOR VEHICLE AND MOTOR VEHICLE

(75) Inventor: Andreas Menke, Tiefenbronn-Lehningen (DE)

(73) Assignee: DR. ING. H.C.F. PORSCHE AKTIENGESELLSCHAFT, Stuttgart (DE)

(21) Appl. No.: 13/099,412

(22) Filed: May 3, 2011

(30) Foreign Application Priority Data
Jun. 11, 2010 (DE) 10 2010 023 473.7

(51) Int. Cl. F15D 1/00; B60P 3/00

(52) U.S. Cl. 137/14; 220/562

(57) ABSTRACT

A method is provided for operating a motor vehicle with a fuel tank and a filler opening that can be closed by a cap. The filer opening and the cap can be covered by a tank flap that can be moved between a covering position and an exposure position. To simplify refueling of the motor vehicle, a pressure equalization between the fuel tank and the environment is carried out if opening or imminent opening of the tank flap is detected.

### CROSS REFERENCE TO RELATED APPLICATION

This application claims priority under 35 USC 119 to German Patent Application No 10 2010 023 473.7 filed on Jun. 11, 2010, the entire disclosure of which is incorporated herein by reference.

### BACKGROUND OF THE INVENTION

1. Field of the Invention

The invention relates to a method of operating a motor vehicle that has a fuel tank with a filler opening that can be closed by a cap and that can be covered by a tank flap that can be moved between a covering position and an exposure position. The invention further relates to a motor vehicle of this kind.

2. Description of the Related Art

German Laid-Open Application DE 10 2009 009 625 A1 has disclosed a diagnostic system for a vehicle that comprises a refuel indication module and a diagnostic module that selectively diagnoses a fault in a tank closure position sensor if the tank closure position sensor indicates that a tank closure remains for a shorter or longer period of time in an open or a closed position. European Patent EP 0 340 062 B1 discloses a filling limitation device for a fuel tank, in which an expansion volume communicates with the atmosphere via a vent circuit. The device has a shut-off valve.

It is the object of the invention to simplify the refueling of a motor vehicle.

### SUMMARY OF THE INVENTION

The invention relates to a method of operating a motor vehicle that has a fuel tank with a filler opening that can be closed by a cap. The filler opening and the cap can be covered by a tank flap that is movable between a covering position and an exposure position. The method includes equalizing pressure between the fuel tank and the environment if opening or imminent opening of the tank flap is detected. The fuel tank preferably is part of a pressurized tank system, especially that of a hybrid vehicle. Hybrid vehicles, especially those referred to as plug-in hybrid vehicles, often are fitted with sealed tanks that function to subject the fuel tank to overpressure during operation to reduce vaporization of fuel. The overpressure must be relieved during or before adding fuel to the fuel tank to enable fuel to be added at conventional filling stations. Pressure equalization can be initiated by actuating a special operating element, e.g. a button or switch. According to one significant aspect of the invention, the pressure equalization is carried out automatically if opening or imminent opening of the tank flap is detected.

The pressure equalization between the fuel tank and the environment preferably is initiated by actuation of the tank flap. Actuation of the tank flap preferably involves push-push actuation, where the opening of the tank flap is initiated by slight pressure on the tank flap.

Opening of the cap preferably is prevented until the pressure equalization between the fuel tank and the environment is complete. The cap cannot be opened until the pressure equalization between the fuel tank and the environment is finished or lower than a fixed or set level (e.g., 10-10 hPa) to safeguard against premature opening of the cap. Before this, the cap either is locked or capable of being turned at will without exposing the filler opening.

Opening or actuation of the tank flap preferably is detected, and the signal detected is used to initiate the pressure equalization between the fuel tank and the environment. The signal can be transmitted wirelessly to the cap. However, the signal also can be transmitted mechanically via an appropriate mechanism.

The pressure equalization may be initiated if the tank flap is moved toward the cap. As part of the push-push function, the opening of the tank flap is initiated by slight pressure on the tank flap. If the tank flap is pressed by a few millimeters, e.g. three millimeters, it springs open automatically when released and exposes the cap underneath.

The invention also relates to a motor vehicle with a fuel tank that has a filler opening that can be closed by a cap. The filler opening and the cap are covered by a tank flap that can be moved between a covering position and an exposure position. The motor vehicle can be operated in accordance with one of the methods described above, by a tank flap movement detection device or tank flap actuation detection device that interacts with a control system so that a pressure equalization between the fuel tank and the environment is carried out if opening or imminent opening of the tank flap is detected. The motor vehicle preferably is a hybrid vehicle having a pressurized tank system. The cap is preferably is in a tank recess that can be covered by the tank flap.

The tank flap may be a push-push tank flap. This is a simple way of enabling convenient operation of the vehicle when refueling.

The tank flap movement detection device or tank flap actuation detection device may comprise a microswitch or a reed contact that is actuated or activated when the tank flap is opened or pressed down. The opening of the tank flap may be registered by a control unit that triggers the pressure equalization. The microswitch can be actuated mechanically. The term “reed contact” denotes a switching contact that comprises contact blades that are fused into a glass tube in a vacuum or inert gas and simultaneously form a contact spring and a magnet armature. The name stems from the reed in woodwind instruments, which resembles the oscillating contact blades. The contact blades are produced from a ferromagnetic material for example, e.g. soft iron, plated with a noble metal. Contact actuation is accomplished by an externally acting magnetic field that is produced by a permanent magnet that is moved into proximity or is produced electrically in an associated magnet coil.

Alternatively or in addition, the motor vehicle may have an opening prevention device for the cap that prevents opening of the cap until the pressure equalization between the fuel tank and the environment is finished.

The motor vehicle is characterized in that the opening prevention device for the cap interacts with the cap from the outside or from the inside to provide a safeguard against premature opening of the cap. The safeguard can be achieved by locking the cap from the outside, e.g. by an electromechanical lock comprising a pin that can be moved in translation and/or rotation or a corresponding pawl. As an alternative or in addition, locking of the cap from the inside can be provided, it being possible for the corresponding signals to be transmitted to the cap wirelessly. Depending on the signals transmitted, transfer of a torque between a top part of the cap and an associated bottom part of the cap can be prevented until the pressure equalization is complete.

Further advantages, features and details of the invention will emerge from the following description, in which various illustrative embodiments are described in detail.

### BRIEF DESCRIPTION OF DRAWING

FIG. 1 is a schematic illustration of a hybrid vehicle in accordance with the invention.

### DETAILED DESCRIPTION OF THE PREFERRED EMBODIMENT

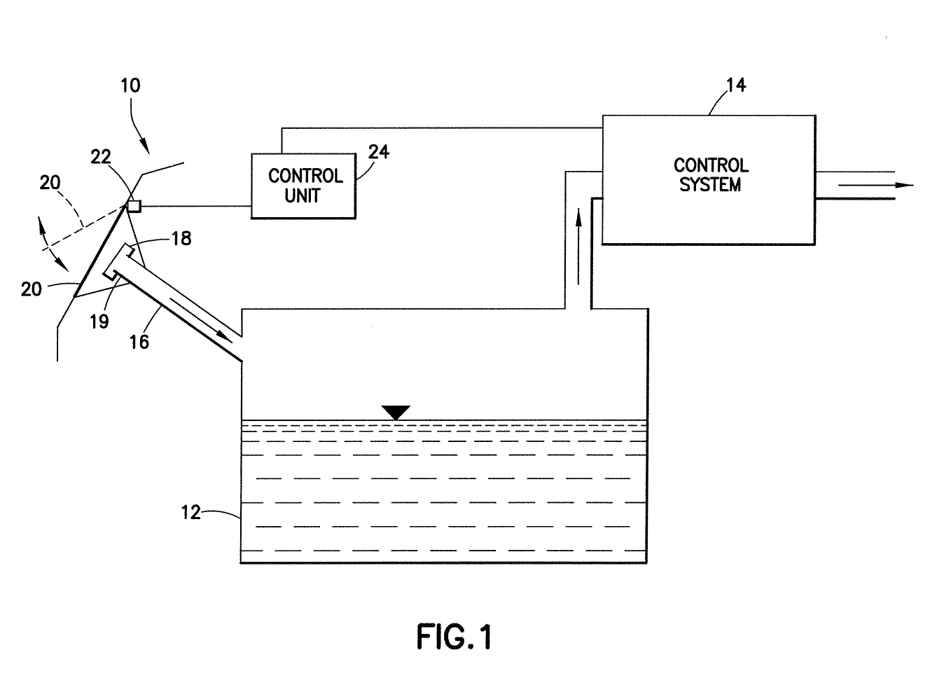

A hybrid vehicle in accordance with the invention is identified by the numeral 10 in FIG. 1. The hybrid vehicle 10 may be a plug-in hybrid vehicle and has a pressurized fuel tank 12 in which the fuel is subjected to overpressure. This overpressure must be relieved before fuel is added to the fuel tank 12 if the intention is to refuel the vehicle 10 at a conventional filling station. Accordingly, the vehicle 10 has a control system 14 that communicates with the fuel tank 12 for equalizing pressure between the fuel tank 12 and the ambient surroundings or environment.

The vehicle 10 combines detection of a refueling operation with a pressure equalization or pressure relief mechanism in a simple manner. More particularly, a filler opening 16 extends from the fuel tank 12 for refilling the fuel tank 12. A cap 18 is removably mounted to the filler opening 16 and may include a locking mechanism 19 that selectively prevents removal of the cap 18. A tank flap 20 is hinged to the vehicle 10 and can be rotated between a covering position where the tank flap covers the cap 18 and the filler opening 16 and an exposure position (broken lines in FIG. 1) where the tank flap 20 exposes the cap 18 and the filler opening 16 for refueling the fuel tank 12. Detection of the refueling operation may be accomplished, when the tank flap 20 is opened, by a detector 22 such as a microswitch 22 in a push-push element or in parallel therewith. The detector 22 also can be a reed contact that detects the opening of the tank flap 20.

The opening of the tank flap 20 is registered electrically by a control unit 24 and triggers an operation of the control system 14 to vent the fuel tank 12, for example, to bring about pressure equalization with the environment. For the venting operation or pressure equalization, it is possible to use vent or pressure equalization valves designed so that venting or pressure equalization takes place in a short time, e.g. in about ten seconds.

Opening of the cap 18 under the tank flap 20 preferably is prevented by the locking mechanism 19 until the pressure equalization is finished.

The locking mechanism 19 that prevents early opening of the cap 18 can electromechanically lock the cap 18 from the outside, e.g. by means of a locking pin or a locking pawl. A locking movement of the locking pin or locking pawl of the locking mechanism 19 can be performed by translation or rotation.

As an alternative, the locking mechanism 19 of the cap 18 can be accomplished within the cap 18 itself by electromechanical locking of torque transfer. The corresponding signals can be transmitted wirelessly into the interior of the cap.

What is claimed is:

1. A method of operating a motor vehicle that has a fuel tank with a filler opening that can be closed by a cap, the filler opening and the cap being covered by a tank flap that can be moved between a covering position and an exposure position, the method comprising equalizing pressure between the fuel tank and the environment if opening or imminent opening of the tank flap is detected.

2. The method of claim 1, wherein the equalizing of pressure between the fuel tank and the environment is initiated by actuation of the tank flap.

3. The method of claim 1, further comprising preventing opening of the cap until the pressure equalization between the fuel tank and the environment is finished.

4. The method of claim 1, further comprising detecting opening or actuation of the tank flap, generating a signal upon detecting opening or actuation of the tank flap and initiating pressure equalization between the fuel tank and the environment in response to the signal.

5. The method of claim 1, the pressure equalization is initiated if the tank flap is moved toward the cap.

6. A motor vehicle, comprising:
a fuel tank;
a filler opening communicating with the fuel tank;
a cap removably mounted to the filler opening;
a tank flap that can be moved between a covering position over the cap and an exposure position exposing the cap;
a control system that communicates with the fuel tank for equalizing pressure between the fuel tank and the environment; and
a tank flap opening detector that communicating with the tank flap and the control system for actuating the control system if opening or imminent opening of the tank flap is detected.

7. The motor vehicle of claim 6, wherein the tank flap is a push-push tank flap.

8. The motor vehicle of claim 6, wherein the tank flap opening detector comprises a microswitch or a reed contact that is actuated or activated when the tank flap is moved.

9. The motor vehicle of claim 6, further comprising an opening prevention device for the cap to prevent opening of the cap until pressure is equalized between the fuel tank and the environment.

10. The motor vehicle of claim 9, wherein the opening prevention device for the cap interacts with the cap from outside or inside.
